(19) United States
(12) Patent Application Publication
(10) Pub. No.: US 2026/0139526 A1
(43) Pub. Date: May 21, 2026

(54) Leaf Element, in Particular Vehicle Door, for a Vehicle, and Vehicle

(71) Applicant: Bayerische Motoren Werke Aktiengesellschaft, Muenchen (DE)

(72) Inventors: Erik BRADEN, Muenchen (DE); Markus KOEDDERITZSCH, Woerthsee (DE)

(21) Appl. No.: 19/121,174

(22) PCT Filed: Oct. 13, 2023
(86) PCT No.: PCT/EP2023/078469

§ 371 Date: Apr. 15, 2025

(30) Foreign Application Priority Data
Oct. 19, 2022 (DE) 10 2022 127 594.9

(51) Int. Cl. E05B 81/90; E05B 79/20; E05B 81/04

(52) U.S. Cl. CPC E05B 81/90; E05B 79/20; E05B 81/04

(57) ABSTRACT

A leaf element for a vehicle, comprising an outer handle element, wherein an operating element is integrated into a first part of the handle element, said operating element being used to electrically unlock a lock, by way of which the leaf element, which can be arranged on the structure of the vehicle such that it can be moved between a closed position and at least one open position, can be secured in the closed position. A second part of the handle element, said second part adjoining and being connected to the first part, is coupled to the lock such that by releasing the second part from the first part and subsequently moving the second part relative to the first part, the lock can be mechanically unlocked.

### BACKGROUND AND SUMMARY

This disclosure relates to a leaf element, in particular to a vehicle door, for a vehicle, in particular a motor vehicle. The disclosure also relates to a vehicle, in particular to a motor vehicle, having at least one such leaf element.

WO 2007/118552 A1 discloses a motor vehicle having a vehicle door which has a door lower part and an upper window part which are mutually separated by a window parapet. A device for activating a vehicle door of a vehicle, having a sensor system which is specified to detect a force acting on the vehicle door and to generate corresponding sensor data, can be derived from WO 2020/01137A1. Furthermore, a motor vehicle having at least one side door which has a door member is known from DE 2017 202 114A1. Moreover, WO 2006/007916 A1 discloses a motor vehicle door having an inner module and an outer module. Moreover, a known door handle unit for activating a lock of a door or of a hatch can be derived from DE 2010 101 164A1 .

It is an object of the present disclosure to achieve a leaf element for a vehicle, and to achieve a vehicle, so that a particularly reliable operation can be implemented in a particularly simple manner.

One aspect of the disclosure relates to a leaf element for a vehicle, in particular for a motor vehicle preferably designed as a motor car, most particularly as a passenger motor car. This means that the vehicle preferably designed as a motor vehicle, in particular as a motor car, and most particularly as a passenger motor car, in its completed state has the leaf element. The leaf element is understood to be a construction element which is to be held or is held, i.e., is disposable or disposed, so as to be movable, in particular pivotable, on a superstructure of the vehicle, which is designed for example as a unitary body, the interior thereof, also referred to as passenger cell or passenger cabin, being formed by the superstructure. In the completed state of the vehicle, the leaf element is thus designed separately from the superstructure and is held on the superstructure so as to be movable, in particular pivotable thereon. The leaf element is in particular assigned a superstructure aperture of the superstructure. The leaf element can be moved, in particular pivoted, relative to the superstructure between a closed position and at least one open position. At least a sub-region of the superstructure aperture is closed by the leaf element in the closed position. In the open position, the leaf element exposes the sub-region of the superstructure aperture. The leaf element can in particular be, for example, a door, in particular a side door, wherein the door is also referred to as a vehicle door. In this way, the superstructure aperture in this instance is designed as a door aperture, for example. In this way, in the open position of the leaf element, a person initially present in an environment of the vehicle and thus of the leaf element can enter the interior by way of the exposed sub-region of the superstructure aperture, for example. Furthermore, the person initially present in the interior can alight from the interior by way of the exposed sub-region of the superstructure aperture, and thus reach the environment, for example. Furthermore, it is conceivable that the leaf element is a hatch, the latter being a rear hatch or a front hatch, for example. For example, the leaf element can be a trunk hatch or a trunk lid, or an engine hood. In this way, the superstructure aperture can be an in particular lateral or rear door aperture, or a front or rear cargo space aperture, for example, so that for example a front or rear cargo space, in particular a trunk, of the vehicle can be accessible for example by way of the sub-region of the superstructure aperture that is exposed in the open position of the leaf element. In this way, the leaf element is an attachment part which is designed separately from the superstructure and is able to be disposed, or is disposed, so as to be movable, in particular pivotable, on the superstructure.

The leaf element has an external handle element which is in particular a handle element on the outside of the door when the leaf element is a door, consequently a vehicle door. Therefore, the handle element is also referred to as an outer handle. For example, the person present in the environment of the vehicle, and thus of the leaf element, can grip the handle element by his/her hand and in the process at least partially encompass the latter, for example, and consequently exert a force on the handle element, and thus via the handle element on the leaf element, for example, in order to handle the leaf element as a result, i.e. in particular in order to be able to move, in particular pivot, the latter relative to the superstructure. For example, the person, or the handle element, can exert such a force on the leaf element that the leaf element is opened by the force, consequently is moved relative to the superstructure from the closed position to the open position. Furthermore, the person present in the environment can exert such a force on the handle element and thus on the leaf element, for example, that the leaf element is closed by the force, consequently is moved from the open position to the closed position. The feature that the handle element is disposed on the outside, thus is an external handle element and thus an outer handle, is understood to mean that the handle element is disposed on an outside of the leaf element, the outside of the latter in the installed position of the leaf element and at least in the closed position of the leaf element, facing away from the interior and facing the environment. The leaf element assumes its installed position in the completed state of the vehicle having the leaf element.

In order to be able to implement a particularly reliable and thus advantageous operation, in particular activation, of the leaf element in a particularly simple manner, it is provided according to the disclosure that integrated into a first part of the handle element is an operating element by way of which a lock is electrically unlockable, by way of which lock the leaf is to be secured, in particular relative to the superstructure, in the closed position, and the leaf element being disposable on the superstructure of the vehicle so as to be movable between the closed position and the open position. The feature that the operating element is integrated into the first part of the handle element and thus into the handle element, is understood to mean in particular that the operating element is held on the first part of the handle element and thus on the handle element, or that the operating element is a constituent part of the first part and thus of the handle element. It is conceivable in particular that the operating element is held on a base of the first part, wherein it is conceivable that the operating element is designed separately from the base. The operating element can be held so as to be immovable or else movable, in particular pivotable, on the base, or on the first part of the handle element and thus on the handle element. The lock, which is designed as a door lock in particular when the leaf element is designed as a door, can be electrically unlocked by way of the operating element. In order to open the leaf element which is initially located in the closed position and is thus closed and locked in the closed position, in particular relative to the superstructure, by way of the lock, for example, the person present in the environment operates, in particular activates, the operating element, for example, as a result of which the lock is electrically unlocked, meaning that electrical unlocking of the lock is caused as a result. The person in particular touches the operating element in the process.

By way of the lock, the leaf element which is able to be disposed or is disposed in the closed position on the superstructure of the vehicle so as to be movable, in particular pivotable between the closed position and the open position, in particular relative to the superstructure, is to be locked or is locked so that any undesirable movement of the leaf element from the closed position to the open position is precluded. By unlocking the lock, the lock releases the leaf element for a movement from the closed position to the open position. In particular, the lock can be a constituent part of the leaf element, so that the lock is able to be moved conjointly, in particular pivoted conjointly, for example with the leaf element relative to the superstructure, between the closed position and the open position. For example, the lock can be adjusted between a locked state or an unlocked state. By unlocking the lock, the lock is moved, i.e., transferred, from the locked state to the unlocked state. For example, if the leaf element is in the closed position, and the lock is meanwhile in the locked state, the leaf element is locked in the closed position and thus in relation to any undesirable movement to the open position relative to the superstructure, by way of the lock. For example, in order to open the initially closed the leaf element, which is thus initially in the closed position, to consequently move the leaf element from the closed position to the open position, the operating element is in particular operated, in particular activated, by the person present in the environment. The lock is electrically unlocked, consequently transferred from the locked state to the unlocked state, by operating, in particular activating, the operating element, so that the lock releases the leaf element for a movement from the closed position to the open position, this taking place relative to the superstructure. For example, a locking element such as, for example, a locking bolt, also referred to as a lock bolt, or a lock bracket, also referred to as a closing bracket, is fastened to the superstructure, in particular on a vehicle pillar of the superstructure, which is designed for example as a door pillar and also referred to as a body pillar or superstructure pillar. In the closed position of the leaf element and in the locked state of the lock, the lock, in particular a fork-like catch of the lock, interacts with the locking element, in particular in a form-fitting manner, for example, as a result of which the leaf element is to be secured, or is secured, in particular in a form-fitting manner, in the closed position. For example, the lock has a lock element which can be, for example, the afore-mentioned fork-like catch. In the closed position of the leaf element and in the locked state of the lock, the lock element interacts with the locking element, in particular in a form-fitting manner, for example, as a result of which the leaf element is to be secured or is secured, in particular in a form-fitting manner, in the closed position. For example, the lock element can be moved, in particular in a translational and/or rotational manner, relative to a base element of the lock, and in particular relative to the locking element, between a locking position and an unlocking position. In the closed position of the leaf element and in the locking position of the lock element, the lock element interacts with the locking element, in particular in a form-fitting manner, as a result of which the leaf element is to be secured, or is secured, in the closed position. Owing to the unlocking of the lock, or during the unlocking of the lock, the lock element is moved from the locking position to the unlocking position, for example, in which any interaction between the lock element and the locking element is precluded. As a result, the leaf element is released for a movement from the closed position to the open position, this taking place relative to the superstructure.

The operating element can be, for example, a mechanical operating element such as, for example, a button, a pushbutton, or a pressure key, wherein the operating element can be moved, in particular in a translational and/or rotational manner, for example relative to the handle element and/or relative to the mentioned base, between an initial position and an operating position. By operating, in particular activating, the operating element, the operating element is moved, for example, from the initial position relative to the handle element and/or relative to the base, to the operating position, as a result of which the lock can be electrically unlocked, consequently electrical unlocking being able to be caused as a result. Furthermore, it is conceivable that the operating element is designed as a touch-sensitive surface, or comprises a touch-sensitive surface, wherein the operating element is operated, i.e., is to be operated, by touching the touch-sensitive surface.

The feature that the lock is able to be electrically unlocked by operating, in particular activating, the operating element, is understood to mean in particular that an electrically operable actuator, in particular an electric motor, is actuated, in particular electrically, by operating the operating element, for example. As a result of the activation of the actuator, the actuator is electrically operated in such a way that the lock element, in particular while utilizing electrical energy and thus electrically, is moved from the locking position to the unlocking position by way of the actuator, for example. This means that the lock element is moved electrically from the locking position to the unlocking position, as a result of which the lock is unlocked electrically, i.e., while utilizing the afore-mentioned electrical energy. Moving the leaf element from the closed position to the open position, following the electrical unlocking, can then be performed manually by the person present in the environment, for example, in particular in that the person exerts a force, in particular a tensile force or a compressive force, on the handle element, thus moving the leaf element relative to the superstructure from the closed position to the open position. Furthermore, it is conceivable that the leaf element is able to be moved, or is moved electrically, i.e., while utilizing electrical energy, from the closed position to the open position relative to the superstructure as a result of the operating element being operated, in particular once the lock has been unlocked, in particular electrically. Provided for this purpose is, for example, an electrically operable motion mechanism which has, for example, the afore-mentioned electrically operable actuator and/or at least one additional electrically operable actuator. By operating the operating element, the motion mechanism is activated, in particular electrically, for example, as a result of which the motion mechanism moves, in particular pivots, the leaf element relative to the superstructure, from the closed position to the open position, while utilizing electrical energy and thus electrically. In this way, the lock can be unlocked in a particularly convenient manner, and the leaf element can be opened in a particularly convenient manner, consequently be moved from the closed position to the open position.

It is preferably provided that the handle element is held on a base member of the leaf element, also referred to as a door member, so as to be immovable, i.e., unable to move, relative to the base member. For example, the leaf element has a carcass, wherein it is conceivable that, in particular in the completed state of the vehicle, the leaf element is to be held, or is held, so as to be movable, in particular pivotable, on the superstructure of the vehicle by way of the carcass. In particular, the carcass can be a constituent part of the base member. In other words, the leaf element is to be held, or is held, so as to be movable, in particular pivotable, on the superstructure of the vehicle by way of the carcass, for example. For this purpose, it is provided, for example, that the leaf element has at least one first hinge part which is fastened, in particular fixed, for example at least indirectly, in particular directly, to the carcass. The first hinge part is, for example, a constituent part of a hinge which also has a second hinge part which is in particular designed separately from the first hinge part. The second hinge part is able to be fastened, or is fastened, at least indirectly, in particular directly, to the superstructure of the motor car, in particular to the afore-mentioned vehicle pillar. The hinge parts are connected, or able to be connected, to one another in a movable, in particular pivotable, manner, so that the carcass by way of the hinge, and the leaf element overall by way of the carcass, is able to be disposed, or is disposed, i.e. is to be held, or is held, so as to be movable, in particular pivotable, on the superstructure. For example, the carcass is at least partially formed from a metallic material. Furthermore, it is conceivable that the leaf element, in particular the base member, has at least one outer paneling element, which is also simply referred to as a paneling element. For example, the outer paneling element is designed separately from the carcass, and is fastened, in particular directly, to the carcass. The outer paneling element is also referred to as a cladding or outer cladding. At least one region of the carcass, in particular in terms of the closed position of the leaf element and in the installed position of the leaf element, the latter assuming an installed position in the completed state of the vehicle having the leaf element, is covered and thus cladded toward the environment, and thus externally, i.e. in a direction pointing away from the interior of the vehicle, by the outer paneling element. For example, the leaf element has an outer skin which is also referred to as a leaf element outer skin, wherein the person present in the environment can see the outer skin with his/her eyes and thus optically perceive the outer skin, and the person present in the environment can directly touch the outer skin (leaf element outer skin) with his/her hand, for example, in particular with his/her fingers, and thus haptically perceive the outer skin, in particular in the completed state of the leaf element and thus of the vehicle overall. This means that the leaf element outer skin is able to be haptically and optically perceived by the person present in the environment. For example, the leaf element outer skin is a surface which is optically and haptically perceivable by the person present in the environment, or is formed by such a surface of the leaf element. It is particularly conceivable here that the abovementioned touch-sensitive surface is also a part of the leaf element outer skin which is referred to as the detection part. The outer paneling element here has an also as paneling outer skin, for example, whereby the explanations above and hereunder pertaining to the leaf element outer skin can also be readily applied to the paneling outer skin and vice versa. For example, the paneling outer skin here is or forms a first part of the leaf element outer skin of the leaf element, also referred to as the entire outer skin.

It is furthermore provided according to the disclosure that a second part of the handle element, which adjoins the first part of the handle element, is coupled, in particular mechanically, to the lock, wherein the second part of the handle element is connected to the first part of the handle element. When mention is made hereunder of the first part and the second part, this is understood to mean the parts of the handle element unless otherwise stated. By releasing, in particular separating, the second part of the handle element from the first part of the handle element, and by subsequently moving the second part of the handle element relative to the first part of the handle element, the lock is able to be unlocked mechanically, in particular purely mechanically, and thus preferably without the use of electrical energy. In other words, by separating the second part from the first part, and by moving the second part relative to the first part, the lock can be unlocked mechanically, in particular purely mechanically, and thus without the use of electrical energy. The second part of the handle element can thus function, be designed, or be used, as an emergency unlocking operating element, wherein the emergency unlocking operating element is also referred to as an emergency unlocking mechanism or emergency unlocking element. This means in particular the following: for example, the operating element is or comprises a sensor, also referred to as a detection sensor, which is able to be operated electrically or electronically, for example, or can be an electric or electronic sensor. The detection sensor can in particular be disposed in the handle element, or in the base. For example, an operation of the operating element caused by the person present in the environment can be detected by way of the detection sensor. It is thus conceivable that the detection sensor is a constituent part of the operating element. For example, if an operation of the operating element caused by the person, i.e. in particular a movement of the operating element from the initial position to the operating position caused by the person, is detected by way of the detection sensor, the first actuator is actuated, in particular as described above, so that the lock is electrically unlocked by way of the first actuator. For example, the first actuator can be a constituent part of the leaf element. It is furthermore conceivable that the detection sensor is a constituent part of the leaf element, in particular in such a manner that the detection sensor is integrated into the handle element. In particular, the detection sensor can be the operating element, or be a constituent part of the operating element. In principle, it is possible that the operating element and/or the detection sensor and/or the first actuator can no longer be supplied with electrical energy or an electrical current, for example due to an accident of the vehicle, because a current supply of the operating element and/or of the first actuator and/or of the sensor (detection sensor) are/is damaged, interrupted or destroyed, for example. In this instance, the lock may potentially no longer be unlocked electrically, because the first actuator can no longer be operated, for example, and/or because an operation or an activation of the operating element can no longer be detected by way of the detection sensor, for example, and/or because the operating element per se can no longer detect its operation. However, as it is now provided according to the disclosure that the second part of the handle element can be released from the first part, and consequently can be moved relative to the first part, as a result of which the lock is mechanically unlocked, in particular purely mechanically unlocked, the second part is, or functions as, an emergency unlocking operating element. It is possible as a result that the lock is mechanically unlocked, in particular when the current supply has failed, i.e., can in particular be emergency-unlocked. For this purpose, the person present in the environment releases, in particular separates, the second part from the first part, for example, whereupon the person present in the environment moves the second part relative to the first part, in particular away from the first part, for example. For example, the person breaks off the second part from the first part, in particular out of the first part. This is understood to mean in particular that the person breaks off the second part from the remainder of the handle element, in particular breaks it out of the remainder of the handle element, for example, as a result of which the person releases, in particular separates, the second part from the first part. Owing to this fact, a particularly high level of reliability can be implemented in a particularly simple manner, such that a particularly advantageous and reliable operation is able to be established. Moreover, the use of an additional, separate emergency unlocking operating element can be avoided, so that a particularly advantageous and reliable operation of the leaf element can be implemented in a manner that is favorable in terms of installation space, weight and costs. Moreover, a particularly advantageous visual appeal of the leaf element and of the vehicle overall can be implemented, because it can be avoided that the visual appeal of the vehicle is impaired by an additional, separate and very remote emergency unlocking operating element, for example.

In order to release the second part from the first part in a particularly simple manner, and to consequently be able to guarantee a particularly advantageous operation, it is provided in an embodiment of the disclosure that the parts of the handle element are formed separately from one another and are connected to one another at at least one connection point, in particular by way of a connection mechanism. The second part is to be released from the first part of the handle element at the connection point.

In this context it has been demonstrated to be particularly advantageous when the parts of the handle element are latched to one another and connected to one another as a result, so that the connection mechanism is preferably formed by a latching mechanism. In order to thus release the second part from a first part, for example, the person present in the environment unlatches the second part from the first part, for example. As a result, the second part can be released from the first part in a particularly simple, rapid and reliable manner. An additional embodiment is distinguished in that the handle element has an outer skin which is able to be perceived optically and haptically by a person present in the environment of the leaf element, the outer skin also being referred to as the handle element outer skin. In other words, the person present in the environment can see the handle element outer skin with his/her eyes and thus optically perceive the latter, and the person present in the environment can directly touch the handle element outer skin, for example with his/her hand, in particular with his/her fingers, and thus haptically perceive the handle element outer skin, in particular in the completed state of the leaf element, in particular of the vehicle overall. In this context it is conceivable in particular that the afore-mentioned touch-sensitive surface is a part of the handle element outer skin which is also referred to as a detection part. It is conceivable in particular that the handle element outer skin is a second part of the leaf element outer skin, i.e., forms a second part of the leaf element outer skin.

It has been demonstrated to be particularly advantageous when the first part of the handle element forms a first sub-region of the handle element outer skin, also referred to as the first outer skin part, and the second part of the handle element forms a second sub-region of the handle element outer skin, also referred to as the second outer skin part. As a result, a particularly simple construction of the handle element can be implemented in such a way that the above-described mechanical unlocking, and consequently the particularly advantageous operation, of the leaf element can be established in a particularly simple manner.

It has been demonstrated to be particularly advantageous here when the handle element has a first sub-region which forms a first outer skin sub-region of the handle element outer skin and which is also referred to as a first member part, and has a first direction of extent and thus extends along the first direction of extent. The handle element here has a second sub-region which forms a second outer skin sub-region of the handle element outer skin and which is also referred to as a second member part. When mention is made hereunder of sub-regions, these are understood to be the sub-regions of the handle element, consequently the member parts of the handle element, unless otherwise stated. It is conceivable that the first sub-region of the handle element, consequently the first member part, projects from the base member in or along the first direction of extent. The first direction of extent is also referred to as the first direction. In the installed position of the leaf element, and in the closed position of the leaf element, the first direction extends in the vehicle transverse direction, for example, in particular toward the outside and thus toward the environment. It is thus provided, for example, that the first sub-region (the first member part) projects from the base member in the first direction.

The second sub-region (second member part) of the handle element adjoins the first sub-region (first member part) of the handle element, wherein the second sub-region of the handle element projects from the first sub-region of the handle element in a second direction of extent, also referred to as second direction, which extends obliquely or perpendicularly to the first direction of extent (first direction). As a result, the second sub-region is spaced apart from the base member, for example, and is disposed so as to at least partially overlap the base member. In particular, the second sub-region extends along the second direction of extent. In the installed position of the leaf element, and in terms of the closed position of the leaf element, the second direction (second direction of extent) extends upward in the vehicle vertical direction, for example, or the second direction points upward in the vehicle vertical direction. For example, in the installed position of the leaf element, and in terms of the closed position of the leaf element, the second sub-region of the handle element is overlapped inward in the vehicle transverse direction, and thus toward the interior, by the base member, and thus overlapped by part of the paneling outer skin, for example. As a result, the person present in the environment can grip the handle element, in particular the second sub-region of the handle element with her/his hand in a particularly advantageous and ergonomic manner, in particular from behind, for example, in particular in such a manner that the person can move at least one of his/her fingers, or a plurality of his/her fingers, between the second sub-region of the handle element and the base member, for example. Thereupon, the person can exert a force on the handle element in a particularly advantageous manner so as to thereby handle the leaf element in a particularly advantageous manner, i.e. in particular to be able to move, in particular pivot, the latter relative to the superstructure.

In order to be able to implement an operation, in particular activation, of the leaf element which is particularly advantageous in terms of haptics, and is ergonomic and comfortable, it is preferably provided that owing to the fact that the second sub-region projects from the first sub-region of the handle element in the second direction of extent, the handle element when viewed overall and thus as a unit, is designed to be L-shaped or V-shaped, thus having the shape of an L or a V. The sub-regions of the handle element form the L shape or the V shape here, wherein the sub-regions of the handle element are respective legs of the L-shape or of the V-shape, respectively. It is provided in particular here that the handle element is linked to the base member of the leaf element by way of the first sub-region of the handle element. In order to be able to implement a particularly reliable operation of the leaf element in a particularly simple manner, it is provided in a further design embodiment of the disclosure that one of the sub-regions, in particular the second sub-region, comprises the first part of the handle element and, as a result, the first outer skin part, wherein the other sub-region, in particular the first part of the handle element, comprises the second part and, as a result, the second outer skin part. In this way, the first outer skin part is a first part, or a first sub-region, of the outer skin sub-region of one of the sub-regions of the handle element, in particular of the first outer skin sub-region, and the second outer skin part is a second part, or a second sub-region, of the outer skin sub-region of the other sub-region of the handle element, in particular of the second outer skin sub-region, for example.

In this context, it is provided in particular that the operating element is integrated into the one sub-region, in particular into the second sub-region, of the handle element, as a result of which a particularly advantageous operation can be implemented.

An additional embodiment is distinguished by a traction means which is connected, in particular mechanically, to the second part of the handle element and which is also referred to as a cable element and is formed from, for example, a metallic material. The traction means is in particular formed as a wire or as a wire cable. The traction means is most particularly formed as a Bowden cable. The second part of the handle element is coupled, in particular mechanically, to the lock by way of the traction means. By releasing, in particular separating, the second part from the first part of the handle element, and by subsequently moving the second part of the handle element relative to the first part of the handle element, a force, in particular a tensile force, can be transmitted from the second part of the handle element to the traction means, for example. In simple terms, it is thus possible to pull at the traction means. The force can be transmitted to the lock by way of the traction means, as a result of which the lock can be unlocked mechanically, in particular purely mechanically. As a result, a particularly simple mechanical unlocking mechanism, in particular emergency unlocking mechanism, of the lock can be guaranteed.

It has been demonstrated to be particularly advantageous when the leaf element is a vehicle door, in particular a side door. A particularly positive operation can be established as a result. In order to implement a particularly advantageous operation, it has been demonstrated to be particularly advantageous when the handle element is an external handle which is disposed on the outside of the door so as to be above or below a door parapet of the vehicle door. In this way, in the installed position of the vehicle door, the latter assuming its installed position in the completed state of the vehicle having the vehicle door, the handle element is disposed in the vehicle vertical direction of the vehicle so as to be at least partially, in particular at least largely, and thus at least to an extent of more than half, or else completely, above or else below the door parapet of the vehicle door. If the leaf element is the vehicle door mentioned, the handle element is also referred to as the external handle or the outside door handle. The door parapet is also simply referred to as the parapet or the window parapet, or edge or bordering edge, or the door parapet is formed by a bordering edge, or coincides with the bordering edge. In particular, the door parapet is or forms an edge, in particular a lower edge, by way of which, for example, a window opening for a glass, also referred to as a glass opening, in particular for a side glass of the vehicle door, is at least partially delimited, in particular toward the bottom in the vehicle vertical direction of the vehicle, in particular in the installed position in terms of the closed position of the vehicle door. For example, the door parapet is formed by the base member, in particular by the outer paneling element. It is conceivable in particular that at least part of the outer paneling element, and thus of the paneling outer skin, in the installed position of the vehicle door, and herein in particular in the closed position of the vehicle door, adjoins the glass opening and/or the door parapet toward the bottom in the vehicle vertical direction of the motor car.

In particular, the base member has an outer skin, which is also referred to as the base member outer skin, wherein the explanations above and hereunder pertaining to the handle element outer skin, to the leaf element outer skin (entire outer skin) and/or to the paneling outer skin can also be readily applied to the base member outer skin, and vice versa. At least part of the base member outer skin is the paneling outer skin, or is formed by the paneling outer skin. In this way, the base member outer skin is, for example, part of the leaf element outer skin of the leaf element. It is provided in particular herein that the first sub-region (first member part) of the handle element projects from the base member outer skin in the first direction (first direction of extent), in particular in the installed position of the leaf element and in the closed position of the leaf element toward the environment, and thus away from the interior. As a result, a particularly advantageous, in particular a particularly ergonomic and comfortable, activation and thus operation of the leaf element can be guaranteed.

A second aspect of the disclosure relates to a vehicle which is preferably designed as a motor vehicle, in particular as a motor car, and most particularly as a passenger motor car, which has at least one leaf element according to the first aspect of the disclosure. Advantages and advantageous design embodiments of the first aspect of the disclosure are to be considered advantages and advantageous design embodiments of the second aspect of the disclosure, and vice versa.

Further details of the disclosure are derived from the description hereunder of a preferred exemplary embodiment and the appended drawing in which:

### BRIEF DESCRIPTION OF THE DRAWINGS

FIG. 1 shows in fragments a schematic perspective view of a vehicle, which is designed as a car, in particular as a passenger motor car, having a leaf element designed as a vehicle door, in particular as a side door; and,

FIG. 2 shows in fragments a schematic and partially sectional perspective view of the leaf element.

Identical or functionally equivalent elements are provided with the same reference signs in the figures.

### DETAILED DESCRIPTION OF THE DRAWINGS

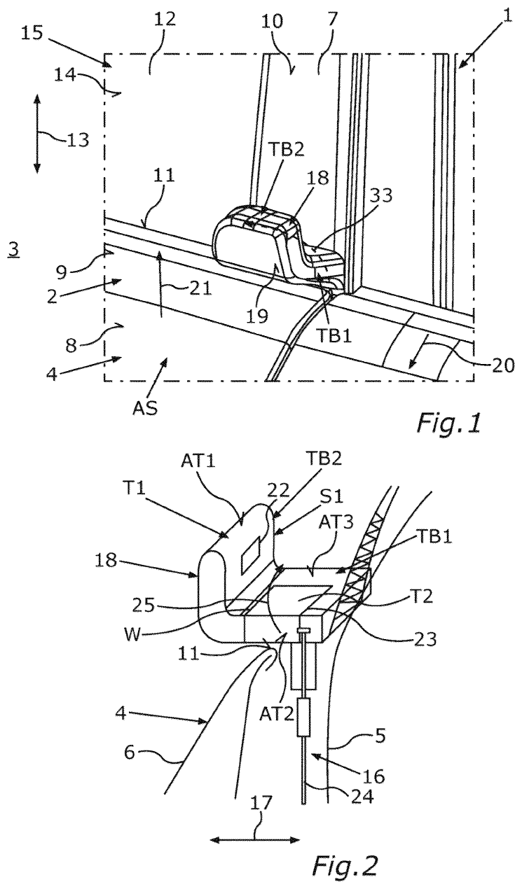

FIG. 1 shows in fragments a schematic perspective view of a motor car 1, presently designed as a passenger motor car, the interior of the latter, also referred to as a passenger cell or a passenger cabin, being formed by a superstructure of the motor car 1, which is in particular designed as a unitary body. The motor car 1 is also referred to as a vehicle or motor vehicle. The motor car 1 has at least one leaf element which in the exemplary embodiment shown in the figures is designed as a vehicle door 2. The vehicle door is also simply referred to as the door. In the exemplary embodiment shown in the figures, the vehicle door 2 is a side door. The vehicle door 2 is assigned a superstructure aperture of the superstructure, wherein the superstructure aperture in the exemplary embodiment shown in the figures is designed as a lateral door aperture of the superstructure. The vehicle door 2 is held, consequently disposed, on the superstructure so as to be movable, in particular pivotable, relative to the superstructure between a closed position and an open position. In the closed position, at least a sub-region of the superstructure aperture is closed by the vehicle door 2. In the open position, the vehicle door 2 exposes at least the sub-region of the superstructure aperture, so that, for example, a person initially present in an environment 3 of the motor car 1, and thus of the vehicle door 2 can enter the interior by way of the exposed sub-region of the superstructure aperture. Furthermore, the person initially present in the interior can for example alight from the interior by way of the exposed sub-region of the superstructure aperture, and thus reach the environment 3.

The vehicle door 2 has a base member 4 which is also referred to as a main member or door member, and which has a carcass 5 which is also referred to as door carcass and can be seen in fragments in FIG. 2. The vehicle door 2 is held on a superstructure of the motor car 1 so as to be movable, in particular pivotable, by way of the carcass 5. The base member 4 has the carcass 5 as well as an outer paneling element 6, which is simply also referred to as the paneling element, and which is designed separately from the carcass 5 and is connected, in particular directly, to the carcass 5. The outer paneling element 6 is also referred to as a door cladding or door outer cladding. In particular in terms of the closed position of the vehicle door, at least one first region of the carcass 5 is covered and thus cladded toward the environment 3 and thus toward the outside, consequently in a direction pointing away from the interior, by the outer paneling element 6.

It can be seen from FIG. 1 that the vehicle door 2 has a cladding element 7 which is designed separately from the outer paneling element 6, for example. For example, the cladding element 7 is held at least indirectly, in particular directly, on the carcass 5. It is conceivable in particular that at least a second region of the carcass 5, at least in terms of the closed position of the vehicle door 2, is overlapped and thus covered, i.e., cladded, toward the environment 3 and thus toward the outside, by the cladding element 7. The vehicle door 2 has an outer skin, which is also referred to as the entire outer skin 8, and in the closed position of the vehicle door 2 shown in FIG. 1 is optically and haptically perceivable by the person present in the environment 3. The entire outer skin 8 is also referred to as the leaf element outer skin. A first part of the entire outer skin 8 is formed by an outer skin of the outer paneling element 6, also referred to as the paneling outer skin 9. A second part of the entire outer skin 8 is formed by an outer skin of the cladding element 7, also referred to as the cladding element outer skin 10. For example, the cladding element 7 is formed from a plastics material. For example, the cladding element 7 is designed as a cover, or the cladding element 7 is also referred to as a cover. It can be provided in particular that in the closed position of the vehicle door 2 a vehicle pillar of the superstructure, which is in particular designed as a B-pillar, is at least partially overlapped and thus cladded in the vehicle transverse direction of the motor car 1 toward the outside, and thus toward the environment 3, by way of the cladding element 7, so that the cladding element 7 is also referred to as the B-pillar cover, for example.

It can be readily seen from FIG. 1 that the vehicle door 2 has a door parapet 11, which is also referred to as a parapet or window parapet, and which is also referred to as a bordering edge, or forms a bordering edge of the motor car 1. Furthermore, the vehicle door 2 comprises a side glass 12, which is also simply referred to as a glass, and which at least in terms of the closed position of the vehicle door 2 is displaceable relative to the carcass 5 and relative to the outer paneling element 6 in the vehicle vertical direction of the motor car 1. In particular, the base member 4 comprises, for example, the carcass 5, the outer paneling element 6 and the cladding element 7. Furthermore, the base member 4 can comprise the side glass 12, for example. It is conceivable that a third part of the entire outer skin 8 is formed by an outer skin of the side glass 12, also referred to as the glass outer skin 14, for example. The vehicle vertical direction is visualized by a double arrow. In particular, the side glass 12, at least in terms of the closed position of the vehicle door 2, can be moved, i.e. displaced, in particular in a translational manner, relative to the carcass 5 and relative to the outer paneling element 6 and also relative to the cladding element 7 in the vehicle vertical direction of the motor car 1, between a closed position shown in FIG. 1 and an opened position not shown. The opened position is also referred to as the glass open position, and the closed position is also referred to as the glass closed position. Here, a window region 15, also referred to as the glass region, is at least partially delimited by the door parapet 11, in particular in the installed position of the vehicle door 2 and toward the bottom in the vehicle vertical direction of the motor car 1. The installed position of the vehicle door 2 is shown in FIG. 1, wherein the vehicle door 2 assumes its installed position in the completed state of the motor car 1 (vehicle) having the vehicle door 2. In the exemplary embodiment shown in the figures, the glass region (window region 15) is a window aperture, also referred to as a glass aperture, which can be delimited by a window frame of the vehicle door 2, for example, wherein the window frame can comprise the door parapet 11, for example. In particular, the window frame is a constituent part of the base member 4, for example. In the closed position, the side glass 12 is at least partially disposed in the window region, in particular in such a manner that the window aperture is at least partially, in particular at least largely, and thus at least to an extent of more than half, or else completely, closed by the side glass 12. It is provided in particular that in the closed position (glass closed position) of the side glass 12, the door parapet 11 in the installed position of the vehicle door 2 adjoins the side glass 12 toward the bottom in the vehicle vertical direction, in particular in terms of the closed position of the vehicle door 2.

It can be seen from FIG. 2 that the vehicle door 2 has a duct 16 which is also referred to as a glass duct or window duct, and which in the installed position of the vehicle door 2 and in the closed position of the vehicle door 2 in the transverse direction toward the outside and thus toward the environment 3 is formed, in particular directly, by the carcass 5 and/or the outer paneling element 6. In particular, in the installed position of the vehicle door 2 and in the closed position of the vehicle door, the duct 16 is overlapped in the vehicle transverse direction of the motor car 1 toward the outside, and thus toward the environment 3, by the outer paneling element 6 and/or by the carcass 5. The vehicle transverse direction of the vehicle (motor car 1) is visualized by a double arrow 17, wherein the closed position and the installed position of the vehicle door are also shown in FIG. 2. In the glass open position of the side glass 12, a sub-region of the side glass 12, also referred to as the glass sub-region, is thus disposed in the duct 16 and thus in particular outside the window region 15, in particular in such a manner that the glass sub-region in the opened position is disposed below the door parapet 11 and also below the window region 15 in the vehicle vertical direction of the motor car 1, in particular in terms of the installed position of the vehicle door 2 and in terms of the closed position of the vehicle door 2. In the closed position (glass closed position) of the side glass 12, the glass sub-region is disposed outside the duct 16 and in the window region 15, in particular in such a manner that the glass sub-region is disposed above the door parapet 11 in the vehicle vertical direction, in particular at least in terms of the installed position and in terms of the closed position of the vehicle door 2. In other words, in the glass closed position the door parapet 11 adjoins the glass sub-region toward the bottom in the vehicle vertical direction. For example, in the closed position (glass closed position) of the side glass 12, the window region 15, or the window aperture, is at least partially, in particular at least largely, and thus at least to the extent of more than half, or else completely, closed by the window sub-region.

The vehicle door 2 furthermore has an external handle element 18, which is consequently on the outside of the door, and which is also referred to as an external handle or door outer handle. In the installed position of the vehicle door 2, and in terms of the closed position of the vehicle door 2, the handle element 18 is disposed in particular partially and most preferably at least largely or completely above the door parapet 11 in the vehicle vertical direction of the motor car 1. The feature that the handle element 18 is disposed on the outside of the door, or externally, thus is an external handle element, or a handle element on the outside of the door, is understood to mean that the handle element 18 is disposed on an external side AS of the vehicle door 2, the external side AS of the latter in the installed position of the vehicle door 2 and at least in the closed position of the vehicle door 2 facing away from the interior and facing the environment 3. The person present in the environment 3 can grip the handle element 18 with his/her hand, for example, and in the process for example at least partially encompass the latter, and consequently exert a force, in particular a tensile force, on the handle element 18 so as for example as a result to open the initially closed vehicle door 2, consequently move the latter from the closed position to the open position relative to the superstructure.

The handle element 18 has an outer skin, also referred to as the handle element outer skin 19, which is optically and haptically perceivable by the person present in the environment 3 of the vehicle door 2, in particular of the motor car 1 overall, by way of which outer skin a fourth part of the entire outer skin 8 is formed, for example, the latter consequently being in particular a fourth part of the entire outer skin 8.

In the exemplary embodiment shown in the figures, the handle element 18 is immovable relative to the carcass 5 and also relative to the outer paneling element 6, in particular relative to the base member 4. For this purpose for example, the handle element 18 is held, in particular fixed, at least indirectly, in particular directly, so as to be immovable on the carcass 5. In order to be able to operate, in particular activate, the vehicle door 2 in a particularly simple manner, in particular in an ergonomic and comfortable manner, the handle element 18 has a first sub-region TB1, also referred to as a first member region or first member part, having a first direction of extent which is also referred to as the first direction and is visualized by an arrow 20 in FIG. 1. The first sub-region TB1 extends along the first direction. In the exemplary embodiment shown in the figures, it is provided that the first sub-region TB1 projects from the base member 4, in particular from the cladding element 7, in the first direction (arrow 20). In particular, in the installed position of the vehicle door 2, and in terms of the closed position of the vehicle door 2, the first direction extends in the vehicle transverse direction, in particular toward the outside. The handle element 18 moreover has a second sub-region TB2 which is also referred to as a second member region or second member part. The second sub-region TB2 projects from the first sub-region TB1 in a second direction of extent, which is also referred to as a second direction and is visualized by an arrow 21 in FIG. 1. The second sub-region TB2 here extends along the second direction of extent. It can be seen by way of the arrows 20 and 21 that the first direction and the second direction extend so as to be mutually perpendicular or oblique, wherein the second direction presently points upward in the vehicle vertical direction, in particular in the installed position of the vehicle door 2 and in terms of the closed position of the vehicle door 2. In particular, the second sub-region TB2 adjoins an end of the sub-region TB1 that faces away from the base member 4 in particular along the first direction, so that or owing to which the handle element 18 in the exemplary embodiment shown in the figures, in particular when viewed overall and thus as a unit, is designed to be L-shaped, thus having an L-shape, in particular when viewed overall. The L-shape here is formed by the sub-regions TB1 and TB2 of the handle element 18. In this context, the sub-regions TB1 and TB2 of the handle element 18 are respective legs of the L-shape, wherein the handle element 18 is linked to the base member 4, in particular to the carcass 5, by way of the sub-region TB1. The sub-region TB2 adjoins the sub-region TB1, presently in particular in such a manner that the sub-region TB2 adjoins an end of the first sub-region TB1 that faces away from the base member 4 in particular along the first direction.

In order to be able to implement a particularly advantageous operation, an operating element 22, which is in particular schematically illustrated in FIG. 2, is integrated into a first part T1 of the handle element 18. It can be seen that the operating element 22 is integrated into the sub-region TB2 so that the sub-region TB2 comprises or has the first part T1 of the handle element 18. In other words, the first part T1 of the handle element 18 is a constituent part of the sub-region TB2, for example. It can be seen from FIG. 2 that the part T1 is part of the second sub-region TB2, so that the operating element 22 is integrated into the second sub-region TB2. The operating element 22 is presently disposed on an internal side S1 of the handle element 18, in particular of the second sub-region TB2, that faces the base member 4, in particular the cladding element 7. It can be particularly readily seen from FIG. 2 that the sub-regions TB1 and TB2 in the installed position of the vehicle door 2, in terms of the closed position of the vehicle door 2, are disposed above the door parapet 11 in the vehicle vertical direction of the motor car 1. The operating element 22, in the installed position of the vehicle door 2 and in terms of the closed position of the vehicle door 2, is disposed here above the door parapet 11 in the vehicle vertical direction of the motor car 1. A lock, which is presently designed as a door lock, can be electrically unlocked by way of the operating element 22, in that the operating element 22 is operated, in particular activated. The lock is a constituent part of the vehicle door 2, for example, and is thus movable conjointly, in particular pivotable conjointly, with the vehicle door 2 relative to the superstructure of the motor car, between the open position and the closed position of the vehicle door 2. By way of the lock, the vehicle door 2 can be held in the closed position relative to the superstructure and thus secured in the closed position, so that the vehicle door 2 by way of the lock can be secured in relation to a movement from the closed position to the open position, this taking place relative to the superstructure. For this purpose, the lock is locked in the closed position of the vehicle door 2, i.e., adjusted to a locked state of the lock. By operating the operating element 22, the lock can be unlocked electrically, i.e., moved, i.e., transferred, electrically from the locked state to an unlocked state of the lock. By moving the lock from the locked state to the unlocked state of the lock, the lock releases the vehicle door 2, which is initially located in the closed position, for a movement from the closed position to the open position taking place relative to the superstructure of the motor car 1.

In order to be able to implement a particularly reliable and thus particularly advantageous operation, in particular activation, of the vehicle door 2 in a particularly simple manner, a second part T2 of the handle element 18, which adjoins the first part T1 of the handle element 18 and is connected to the first part T1, is coupled, in particular mechanically, to the lock, so that the lock is able to be unlocked mechanically, in particular purely mechanically, by releasing the second part T2 from the first part T1 and by subsequently moving the second part T2 relative to the first part T1. It can be seen that the sub-region TB1 in the exemplary embodiment shown in the figures comprises the second part T2, so that the second part T2 of the handle element 18 is a constituent part of the first sub-region TB1, for example.

The moving of the part T2 relative to the part T1 is visualized by an arrow 25 in FIG. 2, wherein in the lock can be unlocked mechanically by the movement visualized by the arrow 25. It is conceivable that the first part T1 is formed by a first main member which is formed integrally, consequently from a single piece, or the first part T1 comprises an integrally formed first main member, consequently formed from a single piece. It is furthermore conceivable that the second part T2 is formed by an integrally formed second main member, consequently formed from a single piece, or the second part T2 comprises an integrally formed main member, thus formed from a single piece. The main members are connected to one another. By releasing, in particular separating, the second part T2 from the first part T1, the second main member is released, in particular separated, from the first main member. By moving the second part T2 relative to the first part T1, the second main member is moved relative to the first main member, as a result of which the lock can be unlocked, in particular purely, mechanically. For example, the sub-region TB2 can comprise at least a first part of the first main member, and the second sub-region TB1 can comprise, for example, at least a second part of the first main member, wherein the second sub-region TB2 comprises the second main member. Consequently, the first main member can partially be a constituent part of the sub-region TB2 and partially be a constituent part of the sub-region TB1. Furthermore, the second main member is a constituent part of the sub-region TB1, for example.

The parts T1 and T2, in particular the first main member and the second main member, are designed separately from one another and connected to one another at at least one connection point which cannot be seen in the figures, and at which the second part T2, or second main member can be released from the first part T1, or first main member, respectively. In particular, the parts T1 and T2, most particularly the main members, are latched to one another at the connection points and connected to one another as a result. In this way, the second part T2 can be released from the first part T1 in a particularly simple manner in that the second part T2 is unlatched from the first part T1.

It can be seen that, for example, the first part T1 has a receptacle 23, wherein the receptacle 23 is disposed in the sub-region TB1 in such a way that the sub-region TB1 has the receptacle 23. The second part T2 is disposed in the receptacle 23, in particular in such a manner that the second part T2 along its circumferential direction, and thus on the external circumference, is at least partially, in particular at least largely or completely, surrounded by the part T1, in particular by a wall region of the part T1. The wall region here is disposed in the sub-region TB1, or the sub-region TB1 comprises the wall region mentioned, respectively.

It can be seen that the first sub-region TB1 forms a first outer skin sub-region of the handle element outer skin 19. The sub-region TB2 forms a second outer skin sub-region of the handle element outer skin 19. In this context, the first part T1 forms a first outer skin part of the handle element outer skin 19, and the second part T2 forms a second outer skin part of the handle element outer skin 19. It is moreover provided that the first part T1 forms a third outer skin part of the handle element outer skin 19. In the exemplary embodiment shown in the figures, this means that the first outer skin part is the second outer skin sub-region, or is at least a constituent part of the second outer skin sub-region, and the second outer skin part is a constituent part of the first outer skin sub-region. The third outer skin part is an additional constituent part of the first outer skin sub-region. In FIG. 1, the first outer skin part is denoted by the reference sign AT1, the second outer skin part by the reference sign AT2, and the third outer skin part by the reference sign AT3. Moreover, the previously mentioned wall region is denoted by the reference sign W. It is provided at least in the exemplary embodiment shown in the figures that the second sub-region TB2 comprises or has the first part T1 and as a result the first outer skin part AT1, wherein the first sub-region TB1 comprises or has the second part T2 and as a result the second outer skin part AT2 and also the third outer skin part AT3. Again in other words, the first part T1, and as a result the first outer skin part AT1, are disposed in the second sub-region TB2, and the second part T2 and the second outer skin part AT2 are disposed in the first sub-region TB1.

In the exemplary embodiment shown in the figures, the in particular purely mechanical unlocking of the lock takes place in the following way, for example: provided is a traction means 24 which is also referred to as a cable element and can be designed, for example, as a wire, or as a wire cable. In particular, the traction means 24 is designed as a Bowden cable, for example. On one side, in particular at one end, the traction means 24 is coupled, in particular mechanically, to the second part T2. On the other side, in particular at the other end, the traction means 24 is coupled, in particular mechanically, to the lock, for example. If the second part T2 is released from the second part T1, and also moved relative to the first part T1, in particular away from the latter, a force which is formed as a tensile force can as a result be exerted on the traction means 24 by the second part T2. The force can be transmitted to the lock by way of the traction means 24, as a result of which the lock is unlocked, in particular mechanically, consequently being transferred from the locked state to the unlocked state. Subsequently, the vehicle door 2 can be opened, consequently moved from the closed position to the open position relative to the superstructure. In simple terms, by releasing the part T2 from the part T1, and by moving the part T2 away from the part T1, it is possible to pull at the traction means 24, as a result of which the lock can be unlocked mechanically, in particular purely mechanically, i.e., entirely without the use of electrical energy or another type of energy. Owing to this fact, a particularly simple mechanical unlocking mechanism, in particular emergency unlocking mechanism, of the lock can be guaranteed. In particular, the part T2, when released from the part T1 and subsequently moved relative to the part T1, in particular moved away therefrom, is moved out of the receptacle 23. As is visualized by the arrow 25, the second part T2 is moved upward in the vehicle vertical direction relative to the part T1, for example, so as to as a result mechanically unlock the lock, in particular by way of the traction means 24.

The parts T1 and T2 are for example released, in particular separated, from one another in such a way, or in such a manner, that the part T2 breaks away or off from the part T1, in particular out of the part T1 and in the process in particular breaks out of the receptacle 23.

It can be seen from FIG. 2 that the outer skin parts AT2 and AT3 are disposed so as to be mutually flush. In particular, the outer skin part AT3 is formed by the part T1, for example. It is conceivable in particular that the part T2 is disposed so as to be entirely flush with the part T1. This is understood to mean that the respective surfaces, and thus in particular parts, of outer skin parts AT2 and AT3, or the outer skin parts AT2 and AT3, are disposed so as to be mutually flush, in particular when viewed along the external walls across the entire handle element. As a result, the part T2 is integrated into the part T1 in an optically particularly advantageous manner.

### LIST OF REFERENCE SIGNS

10 Motor car
2 Vehicle door
3 Environment
4 Base member
5 Carcass
6 Outer paneling element
7 Cladding element
8 Entire outer skin
9 Paneling outer skin
10 Cladding element outer skin
11 Door parapet
12 Side glass
13 Double arrow
14 Glass outer skin
15 Window region
16 Duct
17 Double arrow
18 Handle element
19 Handle element outer skin
20 Arrow
21 Arrow
22 Operating element
23 Receptacle
24 Traction means
25 Arrow
AS External
AT1 Outer skin part
AT2 Outer skin part
AT3 Outer skin part
T1 First part
T2 Second part
TB1 First sub-region
TB2 Second sub-region
W Wall region

1.-10. (canceled)

11. A leaf element for a vehicle, having an external handle element, wherein:
integrated into a first part of the handle element is an operating element by way of which a lock is able to be electrically unlocked, by way of which lock the leaf element is to be secured in the closed position, the leaf element being disposable on a superstructure of the vehicle so as to be movable between a closed position and at least one open position; and
a second part of the handle element, which adjoins the first part and is connected to the first part, is coupled to the lock in such a way that the lock is mechanically unlockable by releasing the second part from the first part and by subsequently moving the second part relative to the first part.

12. The leaf element according to claim 11, wherein:
the parts are formed separately from one another and are connected to one another via at least one connection point at which the second part is to be released from the first part.

13. The leaf element according to claim 12, wherein:
the parts are latched to one another and connected to one another as a result.

14. The leaf element according to claim 11, wherein:
the handle element has an outer skin which is able to be sensed optically and haptically by a person present in an environment of the leaf element, wherein the first part forms a first outer skin part of the outer skin, and the second part forms a second outer skin part of the outer skin.

15. The leaf element according to claim 14, wherein the handle element comprises:
a first sub-region which forms a first outer skin sub-region of the outer skin of the handle element and has a first direction of extent; and
a second sub-region which forms a second outer skin sub-region of the outer skin of the handle element and adjoins the first sub-region, and which projects from the first sub-region in at least one second direction of extent that extends obliquely or perpendicularly to the first direction of extent, as a result of which the handle element is designed to be L-shaped or V-shaped.

16. The leaf element according to claim 15, wherein:
the second sub-region comprises the first part and, as a result, the first outer skin part, and the first sub-region comprises the second part and, as a result, the second outer skin part.

17. The leaf element according to claim 11, comprising:
a cable which is connected to the second part and by way of which the second part is coupled to the lock.

18. The leaf element according to claim 11, wherein:
the leaf element is a vehicle door.

19. The leaf element according to claim 18, wherein:
the handle element is an external handle which is disposed on the outside of the door so as to be above or below a door parapet of the vehicle door.

20. A vehicle having at least one leaf element according to claim 11.
